(19) United States
(12) Patent Application Publication
(10) Pub. No.: US 2012/0278839 A1
(43) Pub. Date: Nov. 1, 2012

(54) ELECTRONIC APPARATUS AND PROGRAM GUIDE DISPLAY METHOD

(76) Inventor: Junko Morimoto, Ome-shi (JP)

(21) Appl. No.: 13/302,798

(22) Filed: Nov. 22, 2011

(30) Foreign Application Priority Data
Apr. 28, 2011 (JP) 2011-102122

(51) Int. Cl. H04N 5/445

(52) U.S. Cl. 725/53

(57) ABSTRACT

According to one embodiment, an electronic apparatus includes a setup module, a data input module, a search module, and a program guide display module. The setup module is configured to set a channel, a program guide of which is not displayed. The data input module is configured to input program guide data of a plurality of channels. The search module is configured to search a viewable program from the program guide data corresponding to the channel. The program guide display module is configured to display a program guide based on the program guide data includes the viewable program.

### CROSS-REFERENCE TO RELATED APPLICATIONS

This application is based upon and claims the benefit of priority from prior Japanese Patent Application No. 2011-102122, filed Apr. 28, 2011, the entire contents of which are incorporated herein by reference.

### FIELD

Embodiments described herein relate generally to an electronic apparatus which displays a program guide based on program guide data, and a program guide display method.

### BACKGROUND

In general, an electronic apparatus, which receives and displays satellite (BS (Broadcasting Satellite), CS (Communications Satellite)) broadcast and ground digital broadcast, has a function of receiving, for example, program information called EIT (Event Information Table) of a plurality of channels, and generating and displaying an electronic program guide (EPG) based on the program information. The electronic apparatus can execute designation or programmed recording of a program, which is a target of viewing (recording), by making use of the electronic program guide (EPG).

In the meantime, in the BS/CS broadcast, there is pay broadcast (pay channel) which requires a subscription for viewing. When the electronic apparatus displays a program guide, the electronic apparatus can display a program guide including programs of all channels regardless of pay channels or free channels, if such channels are channels of receivable broadcast stations (receivable channels). In addition, if the number of receivable broadcast stations (channels) is large (in particular, CS broadcast), it is possible to execute such setting that unsubscribed pay channels are not displayed on the program guide, thereby to make the program guide easier to view.

Pay channels of BS/CS broadcast include a channel which irregularly broadcast a free program or which sets a “free-broadcast day” for broadcasting many free programs. At this time, a free program can be viewed by a receiver which does not subscribe to the channel.

However, since the program guide displays the programs of all channels regardless of pay/free channels, it is not clearly understandable which program of which channel is a free program.

On the other hand, if such setting is executed that an unsubscribed pay channel is not displayed on the program guide, a program of this channel, even if it is a free program, is not displayed on the program guide. Consequently, a user is unable to recognize the presence of such a free program, although the free program can be viewed.

This being the case, even when a program of an unsubscribed pay channel, which the user has an interest in or wishes to view, can be viewed/recorded, it is possible that the user fails to view the program.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary view illustrating the system configuration of a personal computer in the embodiment.

FIG. 3 is an exemplary view illustrating an example of a setup screen for a program guide display setup process in the embodiment.

FIG. 4 is an exemplary flow chart illustrating the procedure of a program guide display process in the embodiment.

FIG. 5 is an exemplary view showing a display example of a program guide in the embodiment.

FIG. 6 is an exemplary view showing a display example of the program guide in the embodiment.

FIG. 7 is an exemplary view showing a display example of the program guide in the embodiment.

FIG. 8 is an exemplary view showing a display example of the program guide in the embodiment.

### DETAILED DESCRIPTION

Various embodiments will be described hereinafter with reference to the accompanying drawings.

In general, according to one embodiment, an electronic apparatus comprises a setup module, a data input module, a search module, and a program guide display module. The setup module is configured to set a channel, a program guide of which is not displayed. The data input module is configured to input program guide data of a plurality of channels. The search module is configured to search a viewable program from the program guide data corresponding to the channel. The program guide display module is configured to display a program guide based on the program guide data comprising the viewable program.

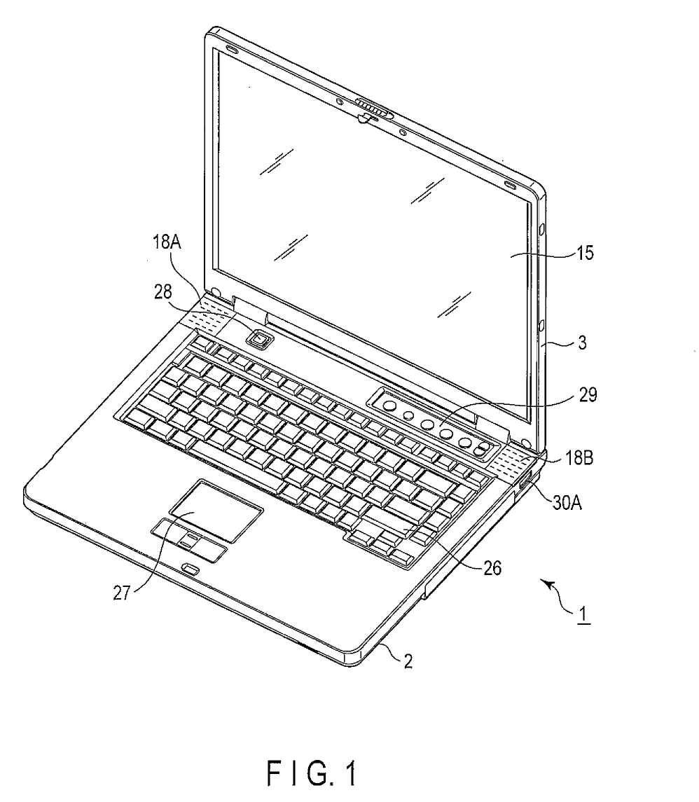

FIG. 1 is a perspective view showing the external appearance of an electronic apparatus according to an embodiment. The electronic apparatus is realized, for example, as a notebook-type personal computer 1. In addition, the electronic apparatus may be realized as a TV receiver, a recorder (e.g. hard disk recorder, DVD recorder) for storing video data, a tablet PC, a slate PC, a car navigation apparatus, a smartphone, etc. The electronic apparatus according to the embodiment is provided with a function for viewing, for example, satellite (BS (Broadcasting Satellite), CS (Communications Satellite)) broadcast and ground digital broadcast.

As shown in FIG. 1, the personal computer 1 includes a computer main body 2 and a display unit 3.

A display 15, which is composed of, e.g. an LCD (liquid crystal display), is built in the display unit 3. The display unit 3 is attached to the computer main body 2 such that the display unit 3 is rotatable between an open position where the top surface of the computer main body 2 is exposed, and a closed position where the top surface of the computer main body 2 is covered.

The computer main body 2 has a thin box-shaped housing. A keyboard 26, a power button 28 for powering on/off the personal computer 1, an input operation panel 29, a pointing device (touch pad) 27, and speakers 18A and 18B are disposed on the top surface of the housing of the computer main body 2. Various operation buttons are provided on the input operation panel 29. The buttons include operation buttons for controlling a TV function (viewing, recording and reproduction of recorded broadcast program data/video data).

An antenna terminal 30A for TV broadcast is provided, for example, on a right-side surface of the computer main body 2. In addition, an external display connection terminal supporting, e.g. the HDMI (high-definition multimedia interface) standard is provided, for example, on a rear surface of the computer main body 2. This external display connection terminal is used for outputting video data (moving picture data), which is included in video content data, such as broadcast program data, to an external display.

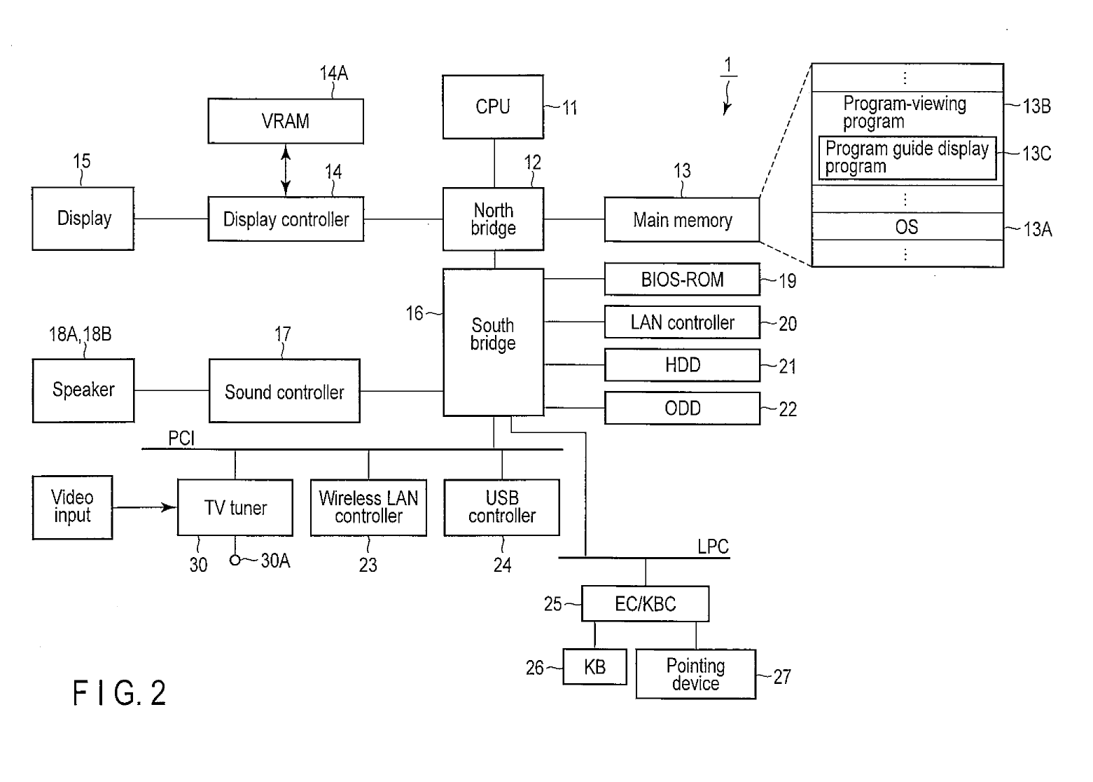

FIG. 2 shows the system configuration of the personal computer 1.

The personal computer 1, as shown in FIG. 2, includes a CPU 11, a north bridge 12, a main memory 13, a display controller 14, a video memory (VRAM) 14A, display 15, a south bridge 16, a sound controller 17, speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, keyboard (KB) 26, pointing device 27, and a TV tuner 30.

The CPU 11 is a processor for controlling the operation of the personal computer 1. The CPU 11 executes an operating system (OS) 13A and an application program, such as a program-viewing program 13B (program guide display program 13C), which are loaded from the HDD 21 into the main memory 13. The program-viewing program 13B is software having a function for viewing video content data including broadcast programs of BS/CS broadcast and ground digital broadcast. The program-viewing program 13B executes a live reproduction process for viewing broadcast program data which is received by the TV tuner 30, a recording process for recording the received broadcast program data in the HDD 21, a reproduction process for reproducing broadcast program data/video data which is recorded in the HDD 21, and a reproduction process for reproducing video content data which is received via a network.

The program-viewing program 13B includes a program guide display program 13C. The program guide display program 13C realizes a function of displaying an electronic program guide (EPG) based on program information. The program guide display program 13C can input the program information, for example, from broadcast waves which are received by the TV tuner 30, or from a network (including the Internet) via the LAN controller 20 or wireless LAN controller 23.

Besides, the CPU 11 executes a BIOS (Basic Input/Output System) that is stored in the BIOS-ROM 19. The BIOS is a program for hardware control.

The north bridge 12 is a bridge device which connects a local bus of the CPU 11 and the south bridge 16. The north bridge 12 includes a memory controller which access-controls the main memory 13. The north bridge 12 also has a function of communicating with the display controller 14.

The display controller 14 is a device which controls the display 15. A display signal, which is generated by the display controller 14, is sent to the display 15. The display 15 displays video, based on the display signal.

The south bridge 16 controls devices on a PCI (Peripheral Component Interconnect) bus and devices on an LPC (Low Pin Count) bus. The south bridge 16 includes an IDE (Integrated Drive Electronics) controller for controlling the HDD 21 and ODD 22, and a memory controller which access-controls the BIOS-ROM 19. The south bridge 16 also has a function of communicating with the sound controller 17 and LAN controller 20.

The sound controller 17 is a sound source device and outputs audio data, which is a target of reproduction, to the speakers 18A and 18B. The LAN controller 20 is a wired communication device which executes wired communication of, e.g. the Ethernet (trademark) standard. The wireless LAN controller 23 is a wireless communication device which executes wireless communication of, e.g. the IEEE 802.11 standard. In addition, the USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the personal computer 1 in accordance with the user's operation.

The TV tuner 30 is a reception device which receives broadcast program data that is broadcast by a television (TV) broadcast signal, and the TV tuner 30 is connected to the antenna terminal 30A. Needless to say, the TV tuner 30 may be configured to receive a TV broadcast signal by using a built-in antenna. The TV tuner 30 is realized as a digital TV tuner which can receive digital broadcast program data of, e.g. BS/CS broadcast and ground digital TV broadcast. In addition, the TV tuner 30 has a function of capturing video data which is input from an external device.

Next, a description is given of an operation for program guide display of the personal computer 1 in the embodiment.

To begin with, a program guide display setup process in the embodiment is described. The CPU 11 starts the program guide display program 13C when a request for the program guide display setup process has been designated by a user operation while the program-viewing program 13B is being executed. The CPU 11 starts the program guide display setup process according to the program guide display program 13C, and causes the display 15 to display a setup screen for the program guide display setup process.

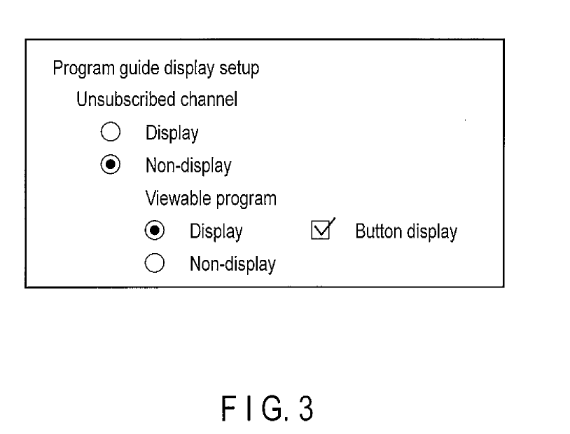

FIG. 3 shows an example of the setup screen for the program guide display setup process. The user can execute the following settings through the setup screen by operating the pointing device 27 or keyboard 26.

As shown in FIG. 3, on the setup screen, “Display” or “Non-display” can be set for a program guide of unsubscribed channels. Specifically, by setting “Non-display” for the unsubscribed channels, the program guide of the unsubscribed pay channels can be set in “Non-display” on a channel-by-channel basis. It is assumed that the unsubscribed channels include not only an unsubscribed pay channel, but also a channel which can be subscribed on a program-by-program basis, but of which the number of unsubscribed, unviewable programs is large (i.e. a channel of which the number of subscribed programs is less than a predetermined reference value). It is assumed that a channel, of which the number of viewable programs subscribed on a program-by-program basis is the reference value or more, is treated as a subscribed channel.

When “Non-display” has been set for unsubscribed channels on the setup screen, it is possible to set, on the setup screen, “Display” or “Non-display” for a program guide of unsubscribed channels including viewable programs. When “Display” has been set for the program guide of channels including viewable programs, the program guide of channels including viewable programs can be displayed even if “Non-display” is set for the program guide of unsubscribed channels.

In addition, on the setup screen, when “Display” has been set for the program guide of channels including viewable programs, it is possible to designate “Button display” indicating that a viewable program has been searched from unsubscribed channels. Specifically, when a viewable program is included in unsubscribed channels, the user can be prompted by “Button display” to confirm whether or not to display the program guide. After “Button display” has been set, if a request for displaying the program guide of channels including viewable programs is input, the program guide of channels including viewable programs is displayed. When “Button display” is not set, if an unsubscribed channel includes a viewable program, the program guide of this channel is automatically displayed.

Meanwhile, the program guide of subscribed channels is displayed regardless of the setup content relating to unsubscribed channels.

The CPU 11 records setup data, which has been set through the setup screen, for example, in a nonvolatile recording medium such as the HDD 21. In the program guide display process which will be described below, the CPU 11 displays the program guide by referring to the setup data recorded in the HDD 21.

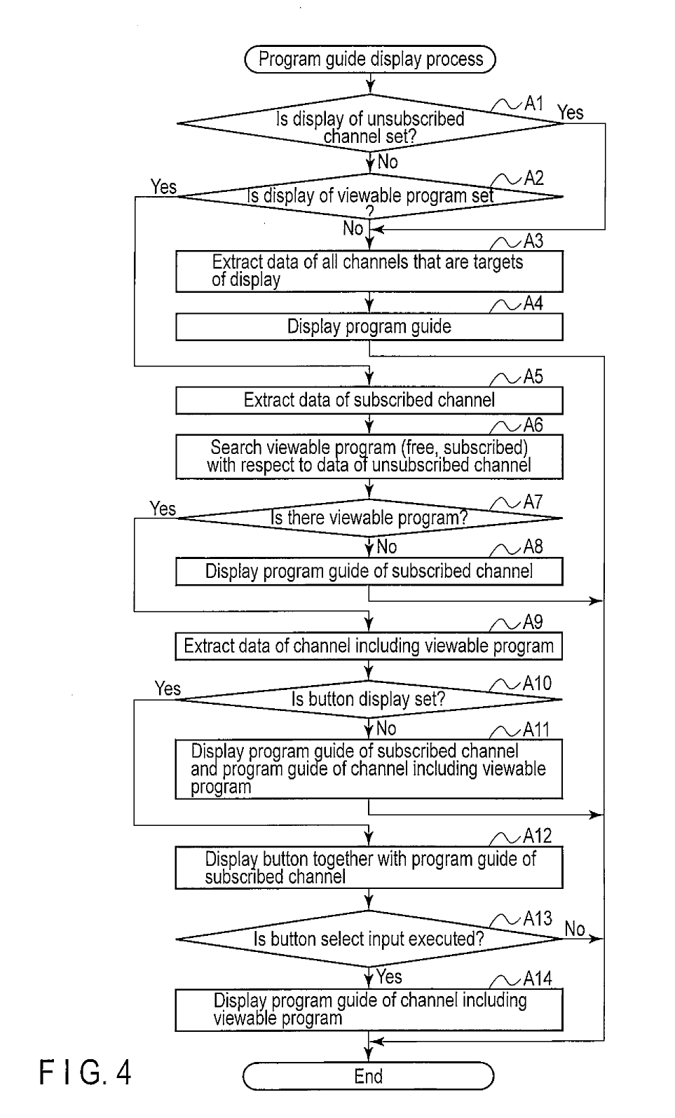

Next, the program guide display process in the embodiment is described with reference to a flow chart of FIG. 4.

It is assumed that the personal computer 1 received program information of a plurality of receivable broadcast stations (channels) via, e.g. the TV tuner 30, and recorded the program information in the HDD 21. The CPU 11 can create program guide data, based on the program information recorded in the HDD 21, and can cause the display 15 to display a program guide on a channel-by-channel basis.

To start with, if display of the program guide has been instructed by the user operation, the CPU 11 starts the program guide display process according to the program guide display program 13C. Based on the setup data recorded in the HDD 21, the CPU 11 determines whether such setting has been made to display the program guide of unsubscribed channels.

If the setting to display the program guide of unsubscribed channels has been made (Yes in block A1), the CPU 11 extracts program guide data of all channels that are targets of display (block A3), and causes the display 15 to display the program guide.

In this case, the CPU 11 searches the program guide data of unsubscribed channels for viewable programs within a predetermined data/time range which is a display target of a predetermined program guide. The “viewable programs”, in this context, include, for example, a free program, and a program which is subscribed on a program-by-program basis. The data/time range for the search may be an hour-based range such as three hours or six hours, or a range of the present day or one week, or all the obtainable range. When there are a plurality of unsubscribed channels, the cup 11 searches for viewable programs with respect to the program guide data of each channel.

The CPU 11 creates and displays a program guide based on both program guide data of channels which are viewable without subscription or the like, and program guide data of subscribed and unsubscribed channels. In addition, the CPU 11 displays, in the program guide, a field of viewable programs (a free program and a program subscribed on a program-by-program basis), which have been searched from the unsubscribed channels, in a mode (emphasis mode) different from the mode of display of other unviewable programs of the unsubscribed channels.

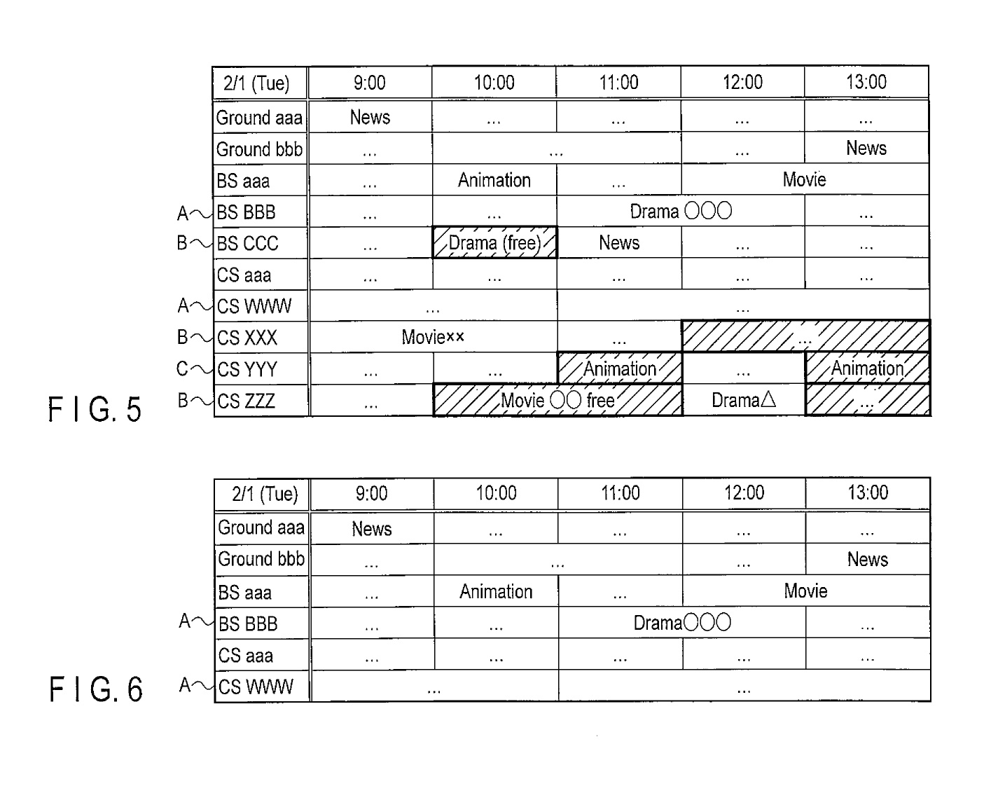

FIG. 5 shows a display example of the program guide in the case where the display of the program guide of unsubscribed channels is set.

In FIG. 5, a channel A (e.g. “BS BBB”, “CS WWW”) indicates a subscribed pay channel, a channel B (e.g. “BS CCC”, “CS XXX”) indicates an unsubscribed pay channel, and a channel C (e.g. “CS YYY”) indicates a pay channel which is subscribed on a program-by-program basis. The other channels are channels which are viewable without subscription.

The program guide shown in FIG. 5 displays, in a mixed fashion, program guides of channels which are viewable without subscription, subscribed channels and unsubscribed channels. In addition, in the program guide of unsubscribed channels (channels B), viewable programs are displayed in a mode different from the mode of display of other unviewable programs, for example, in an emphasis mode by changing a color of a program field, a background color in the program field, a character shape (font, thickness) or a character color. When the display 15 is configured to be able to effect 3D display of a partial area of the display surface, the field of the viewable program may be 3D-displayed. Incidentally, other display modes may be used. Thereby, it is possible to easily distinguish, from the program guide, viewable programs which are broadcast by unsubscribed channels.

As described above, when the setting to display the program guide of unsubscribed channels has been made, the program guide of unsubscribed channels and the program guide of other channels are displayed in a mixed fashion, but the viewable programs are displayed with emphasis in the mode different from the mode of display of the other programs. Thus, the user can easily understand, from the program guide, the viewable programs of the unsubscribed channels. In addition, since the program guide of unsubscribed channels and the program guide of other channels are displayed in a mixed fashion, the user can understand, without performing an operation of switching the program guide, a plurality of viewable programs in the same time zone or near time zones, which are included in the unsubscribed channels and other channels.

Besides, the program guide of unsubscribed channels include not only viewable programs such as free programs, but also unviewable programs. Thus, the user can easily find a program of interest from the program guide of unsubscribed channels. If the user finds a program of interest, the user can subscribe to the pay channel of the program and can more enjoy digital broadcast. Since the user can easily find a free program or a program of interest, broadcasters will have a good chance of winning new subscribers.

Next, when non-display of the program guide of unsubscribed channels is set (No in block A1), the CPU 11 determines, based on the setup data, whether display of viewable programs is set or not. If display of viewable programs is not set (No in block A2), the CPU 11 extracts program guide data of all channels which are targets of display (block A3), and causes the display 15 to display a program guide.

In this case, the CPU 11 creates and displays the program guide, based on the program guide data of channels which are viewable without subscription, and subscribed channels.

FIG. 6 shows a display example of the program guide in the case where non-display of the program guide of unsubscribed channels is set and non-display of the program guide of viewable programs is set. As shown in FIG. 6, the program guide of channels, which are viewable without subscription, and subscribed channels (channels A) is displayed.

Thereby, even when a viewable program of an unsubscribed channel is broadcast, the data of the unnecessary channel is not included in the program guide. Thus, the program guide becomes easier to view, for the user who does not view this viewable program.

On the other hand, when display of viewable programs is set (Yes in block A2), the CPU 11 extracts and records program guide data of the subscribed channels (block A5). In addition, in the same manner as described above, the CPU 11 searches the program guide data of unsubscribed channels for viewable programs within the predetermined data/time range which is the display target of the predetermined program guide (block A6).

When no viewable program has been searched from the unsubscribed channels (No in block A7), the CPU 11 creates and displays a program guide based on program guide data of channels which are viewable without subscription, and program guide data of subscribed channels (block A8).

When a viewable program has been searched from the unsubscribed channels (Yes in block A7), the CPU 11 extracts and records program guide data of the unsubscribed channel including the viewable program (block A8). Specifically, in the same manner as described above, the CPU 11 searches the program guide data of unsubscribed channels for viewable programs within the predetermined data/time range which is the display target of the predetermined program guide, and extracts the program guide data of the channel, of which the viewable program has been searched.

Then, the CPU 11 refers to the setup data and determines whether “Button display” indicating that a viewable program has been searched from unsubscribed channels is set or not. When “Button display” is set (Yes in block A10), the CPU 11 creates and displays a program guide based on program guide data of channels which are viewable without subscription, and program guide data of subscribed channels, and also displays a button indicating that a viewable program has been searched from unsubscribed channels (block A12). Specifically, while keeping non-display of a program guide of unsubscribed pay channels, the CPU 11 additionally displays, on the program guide, the button for displaying a program guide of unsubscribed channels including viewable programs (i.e. the button for a transition to an additional display state). By this button display, the user can recognize, for example, that free programs are included in unsubscribed channels.

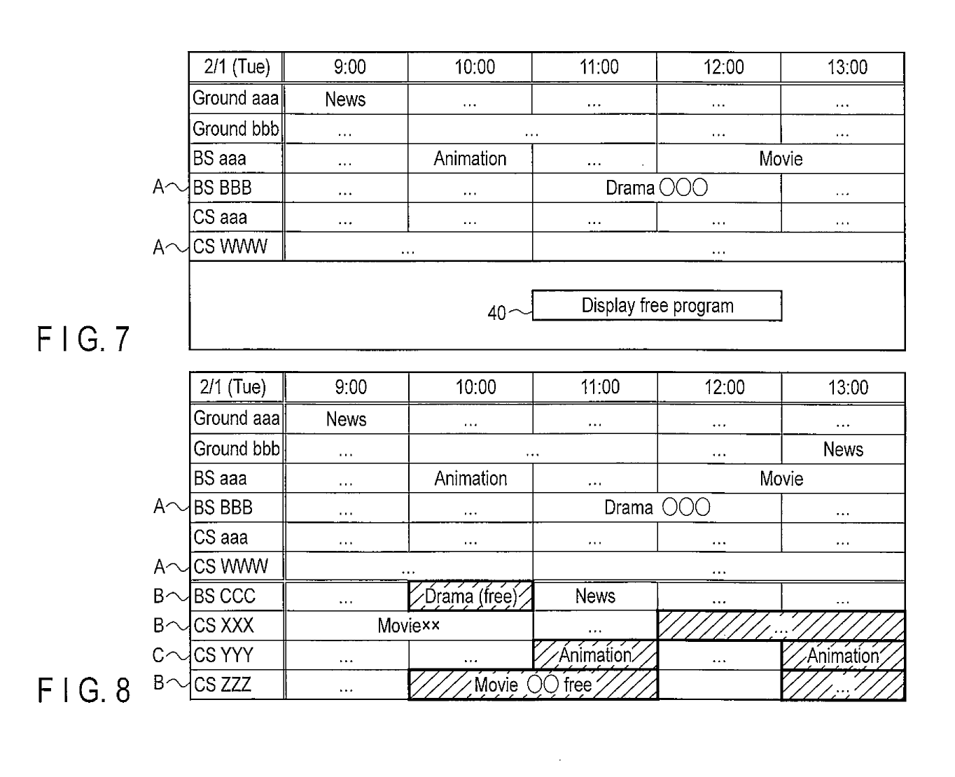

FIG. 7 shows a display example of the program guide to which a button 40 indicating that a viewable program has been searched from unsubscribed channels is added.

In the example shown in FIG. 7, the button 40 has a description “Display free programs”. By this description of the button 40, the user is notified that a program guide of channels including viewable programs can be displayed in accordance with an operation of selecting the button 40. When there is a viewable program in unsubscribed channels, the program guide of the unsubscribed channels is not automatically additionally displayed, but the button 40 is displayed. Thus, advantageously, there is no need to present an unnecessary program guide to the user who does not always need the information of viewable programs of unsubscribed channels.

When an input to select the button 40 has been executed by, for example, the user's operation of the pointing device 27 (Yes in block A13), the CPU 11 creates a program guide based on the program guide data of unsubscribed channels including viewable programs, and additionally displays this program guide to the previously displayed program guide (block A14).

FIG. 8 shows an example in which a program guide of unsubscribed channels including viewable programs is additionally displayed.

In the example shown in FIG. 8, a program guide of a plurality of unsubscribed channels (channels B and C) including viewable programs is added to the previously displayed program guide. Specifically, the program guide of channels which are viewable without subscription and channels which are subscribed is displayed distinguishably from the unsubscribed channels including viewable programs. Thereby, a plurality of viewable programs in the same time zone or near time zones, which are included in the plural unsubscribed channels, can easily be understood.

In addition, in the program guide of unsubscribed channels, viewable programs are displayed in a mode which easily distinguishes these viewable programs from other programs, in the same manner as in FIG. 5. Therefore, the viewable programs of the unsubscribed channels can easily be recognized from the program guide.

Furthermore, like the case of FIG. 5, the program guide of unsubscribed channels shown in FIG. 8 includes not only viewable programs such as free broadcast programs, but also unviewable programs. Thus, the user can easily find a program of interest from the program guide of unsubscribed channels. Besides, since the program guide of unsubscribed channels is additionally displayed in accordance with the operation of selecting the button 40, this program guide can be displayed only when the user has an interest in viewable programs and needs the program guide.

In the above description, the button 40 is displayed together with the program guide, and the program guide of unsubscribed channels including viewable programs is displayed by the operation of selecting the button 40. Alternatively, by a method different from the use of the button 40, the user may be notified that a viewable program has been searched from unsubscribed channels, and the display of the program guide of the unsubscribed channels may be instructed after the notification. For example, a message, such as “A free program is broadcast in unsubscribed channels”, may be displayed together with the program guide when a viewable program has been searched from unsubscribed channels. After this message is displayed, the program guide may be displayed in accordance with, for example, a predetermined key operation on the keyboard 26.

In the above description, when at least one free program or one viewable program, which is subscribed on a program-by-program basis, is included in the day/time range that is the target of search of unsubscribed channels, the program guide of the unsubscribed channel including this viewable program can be displayed. Alternatively, the program guide of unsubscribed channels may be displayed when the ratio of viewable programs in the day/time range that is the target of search is a reference value or more. The ratio in the day/time range is, for example, a ratio of viewable programs to all programs in the day/time range, or a ratio of the total time of all viewable programs to the time of the day/time range. In addition, the reference value may be determined in advance in the program guide display program 13C, or may be determined in accordance with an instruction from the user.

In block A10, when it is determined that “Button display” is not set (No in block A10), the CPU 11 displays, in a distinguishable mode, the program guide of channels which are viewable without subscription and subscribed channels and the program guide of unsubscribed channels (channels B and C) including viewable programs, as shown in FIG. 8, so that the viewable programs may be distinguished by emphasis display from other programs (block All). Thereby, the user can easily understand that viewable programs are included in the unsubscribed channels and can easily recognize which of the programs is a viewable program.

As has been described above, in the personal computer 1 (electronic apparatus) of the present embodiment, as regards unsubscribed channels which have been set by the program guide display setup process so that their program guide is not displayed, if a viewable program is included in the unsubscribed channels, the program guide of the unsubscribed channels can be displayed. Therefore, viewable programs of the unsubscribed channels can easily be understood.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the embodiment may be stored as a computer-executable program viewing program (program guide display program) in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

What is claimed is:

1. An electronic apparatus comprising:
a setup module configured to set a channel, a program guide of which is not displayed;
a data input module configured to input program guide data of a plurality of channels;
a search module configured to search a viewable program from the program guide data corresponding to the channel; and
a program guide display module configured to display a program guide based on the program guide data comprising the viewable program.

2. The electronic apparatus of claim 1, wherein the program guide display module is configured to display a program guide comprising the viewable program and an unviewable program, based on the program guide data comprising the viewable program.

3. The electronic apparatus of claim 2, wherein the program guide display module is configured to display the viewable program in a first mode different from a second mode of display of the unviewable program.

4. The electronic apparatus of claim 2, wherein the program guide display module is configured to display a first program guide based on the program guide data comprising the viewable program, and a second program guide based on the program guide data excluding the channel set by the setup module.

5. The electronic apparatus of claim 1, further comprising:
a display module configured to display an object indicating that the viewable program hassearched by the search module; and
an input module configured to input a display request for displaying the program guide comprising the viewable program, after the display of the object by the display module,
wherein the program guide display module is configured to display the program guide when the display request input.

6. A program guide display method comprising:
setting a channel, a program guide of which is not displayed;
inputting program guide data of a plurality of channels;
searching a viewable program from the program guide data corresponding to the channel; and
displaying a program guide based on the program guide data comprising the viewable program.

7. A computer-readable, non-transitory storage medium having stored thereon a computer program which is executable by a computer, the computer program controlling the computer to execute functions of:
setting a channel, a program guide of which is not displayed;
inputting program guide data of a plurality of channels;
searching a viewable program from the program guide data corresponding to the channel; and
displaying a program guide based on the program guide data comprising the viewable program.
